(19) United States
(12) Patent Application Publication
(10) Pub. No.: US 2021/0008825 A1
(43) Pub. Date: Jan. 14, 2021

(54) FORMER

(71) Applicant: Keymac USA LLC, Charlotte, NC (US)

(72) Inventor: Michael Bradley, Charlotte, NC (US)

(73) Assignee: Keymac USA LLC, Charlotte, NC (US)

(21) Appl. No.: 16/926,724

(22) Filed: Jul. 12, 2020

(30) Foreign Application Priority Data
Jul. 12, 2019 (GB) 1910069.2

(51) Int. Cl. B31B 50/44; B31B 50/00; B31B 50/04; B31B 50/06

(52) U.S. Cl. CPC B31B 50/44; B31B 50/006; B31B 2120/302; B31B 50/06; B31B 50/042

(57) ABSTRACT

A forming machine for erecting a packaging article, the machine comprising a female cavity and a plunger which moves up and down in a generally vertical cycle and which can push a packaging article down into the cavity when moving down, in which the plunger is driven to move up and is not driven to move down.

The present invention relates generally to a former and particularly, although not exclusively, to a packaging former for cartons, trays and the like.

It is known to use plungers to form cartons and the like. For example a carton is provided in a flat form and a plunger can be used to erect the carton by pushing it down into a female cavity. In known systems the plunger is driven to move up and driven to move down in a vertical cycle. The problem with this is that the plunger can easily jam (for example if more than one carton is mistakenly loaded). In addition, a plunger being driven down creates safety issues.

An aspect of the present invention provides a forming machine for erecting a packaging article, the machine comprising a female cavity and a plunger which moves up and down in a generally vertical cycle and which can push a packaging article down into the cavity when moving down, in which the plunger is driven to move up and is not driven to move down.

The plunger may be driven (e.g. pushed or lifted) up.

The plunger may be allowed to drop down under its own weight i.e. it moves in the absence of drive.

The machine may comprise a cam.

The cam may be an eccentric cam.

The cam may be non-circular, for example generally oval, ovoid, elliptical or ellipsoidal. The machine may comprise a cam shaft. The cam shaft may be balanced.

A cam follower may be provided on or by the cam.

The cam follower may be and/or may carry an arm which in turn controls/carries the plunger.

In some embodiments the plunger is not directly connected to a mechanical drive. For example a plunger or plunger arm may roll on top of a cam profile.

The machine may comprise a plunger arm which pivots up and down.

In some embodiments if the plunger arm does not reach a bottom dead centre position the machine stops downwards motion of the plunger.

A sensor may be provided to stop motion (including stopping the down motion of the plunger) to allow clearing cartons or objects.

A plunger or plunger arm may roll on top of a cam profile.

The machine may further comprise a hopper, for example a hopper from the top or bottom of which packaging articles (cartons, trays, boxes and the like) can be taken e.g. using vacuum cups. A low level sensor may be provided for the hopper.

The machine may further comprise an inbound conveyor, for example for taking articles from a store (e.g. a hopper) and moving them towards or to the female cavity.

The machine may further comprising an outbound conveyor, for example for receiving erected articles and moving them away from the machine.

A further aspect provides a method of erecting a packaging article comprising: providing a female cavity and a plunger which moves up and down in a generally vertical cycle; pushing a packaging article down into the female cavity by moving the plunger down; driving the plunger up; and allowing the plunger to drop down.

Articles may, for example, be converted/moved from a generally flat configuration to an assembled/erected configuration.

Some aspects and embodiments of the present invention relate to the idea of using a plunger which is not driven when moving down in use.

In some embodiments a cam is used. A cam follower is positioned on the cam and is or carrier an arm which in turn controls/carries a plunger. For example, therefore, the plunger is pushed up and then allowed to drop.

In some embodiments the plunger drops under its own weight.

In some embodiments a plunger arm pivots up and down.

In some embodiment when a plunger arm doesn't reach bottom dead centre a sensor stops the motion to clear cartons or objects, stopping the down motion of the plunger.

In some embodiments a cam shaft is balanced.

In some embodiments a plunger is not directly connected to a mechanical drive. It (or a plunger arm, for example) may roll on top of a cam profile.

The cam may be an eccentric cam.

The cam may, for example, be non-circular. It could, for example, be generally oval, ovoid, elliptical or ellipsoidal.

The present invention also provides a packaging machine having a plunger arrangement as described herein.

Different aspects and embodiments of the invention may be used separately or together.

Embodiments of the present invention are shown, by way of example, with reference to the accompanying drawings, in which:

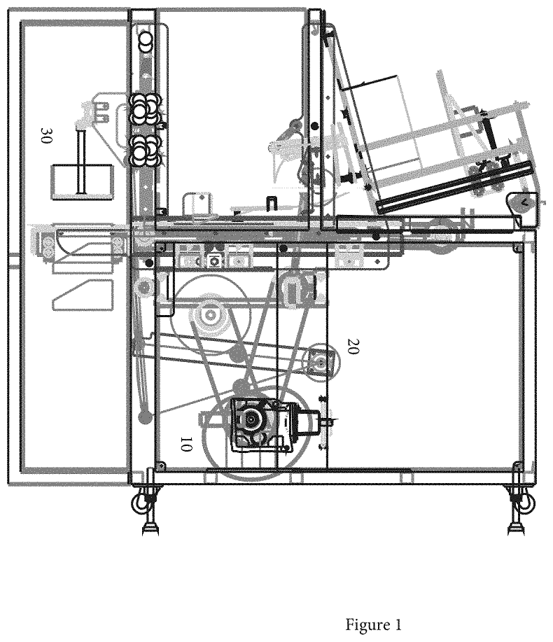

FIG. 1 illustrates a schematic drawing of a packaging machine formed according to an embodiment of the present invention;

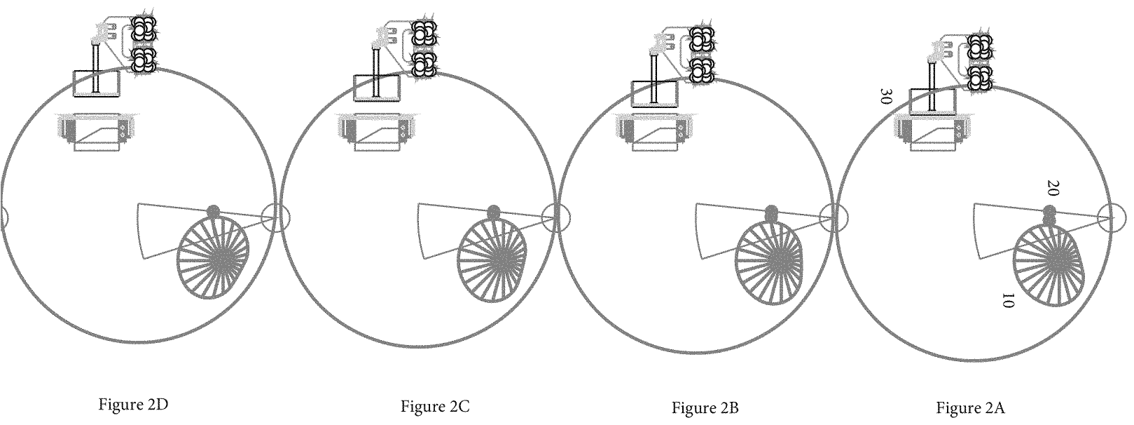

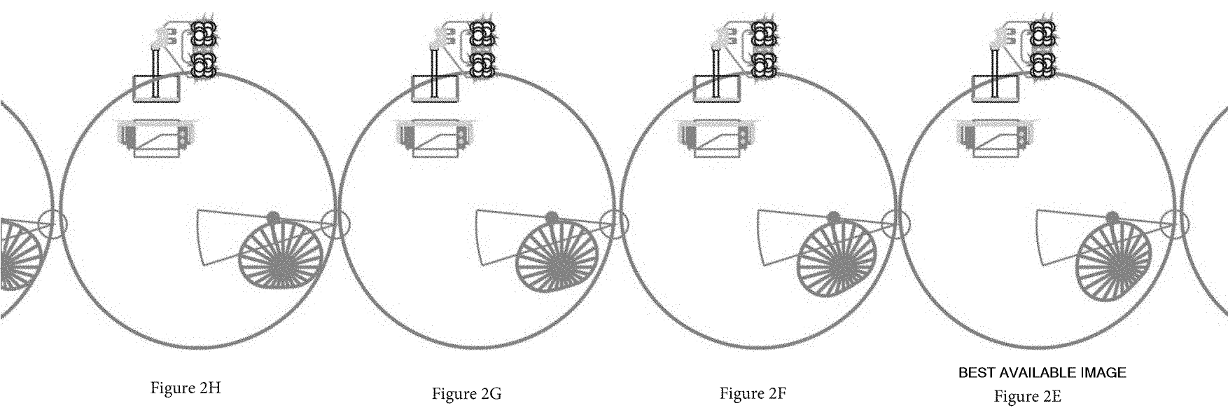

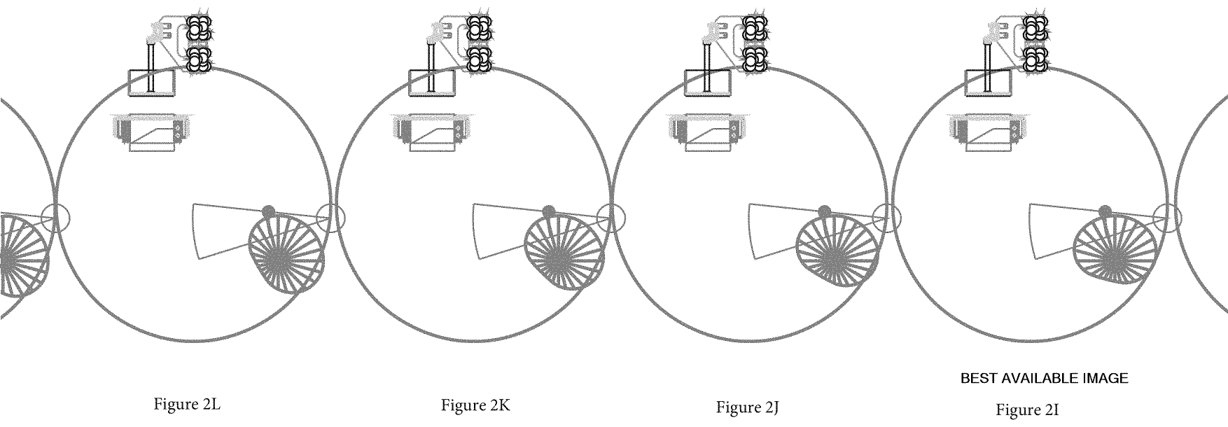

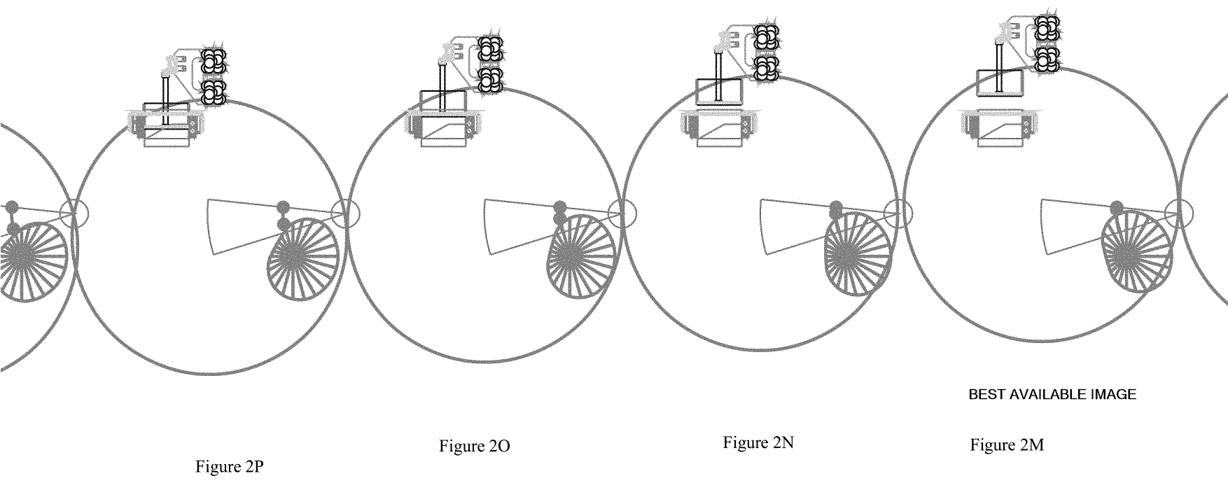

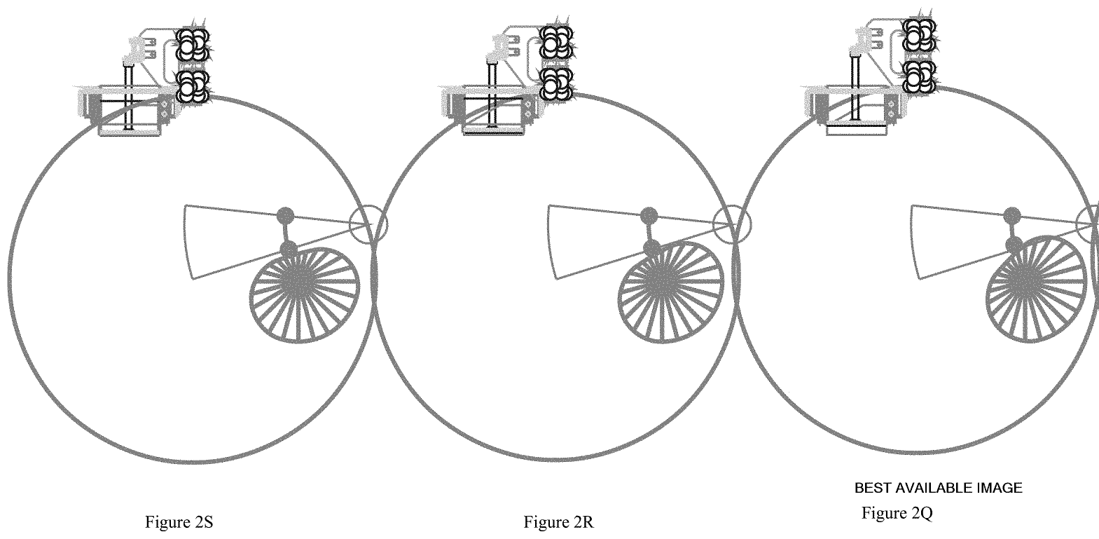

FIGS. 2A to 2S illustrate the vertical cycle/plunge process of the machine of FIG. 1;

FIG. 3 illustrates a packaging machine formed according to a further embodiment. The plunger is shown in an uppermost position;

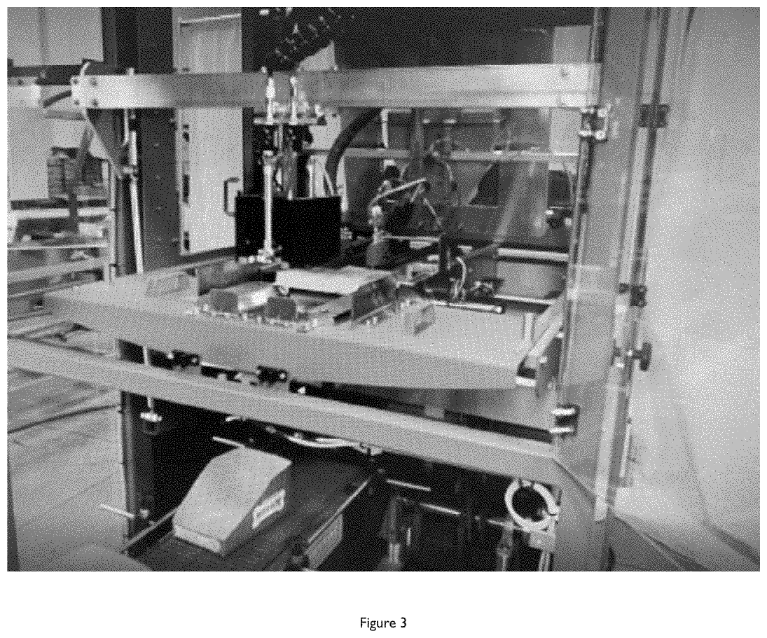

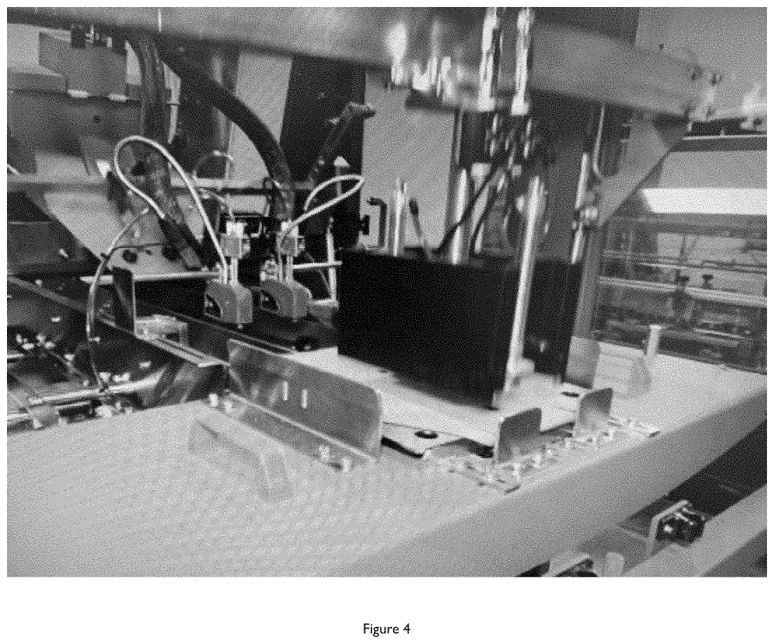

FIG. 4 illustrates a carton is moved over the cavity and beneath the plunger and the plunger is allowed to drop;

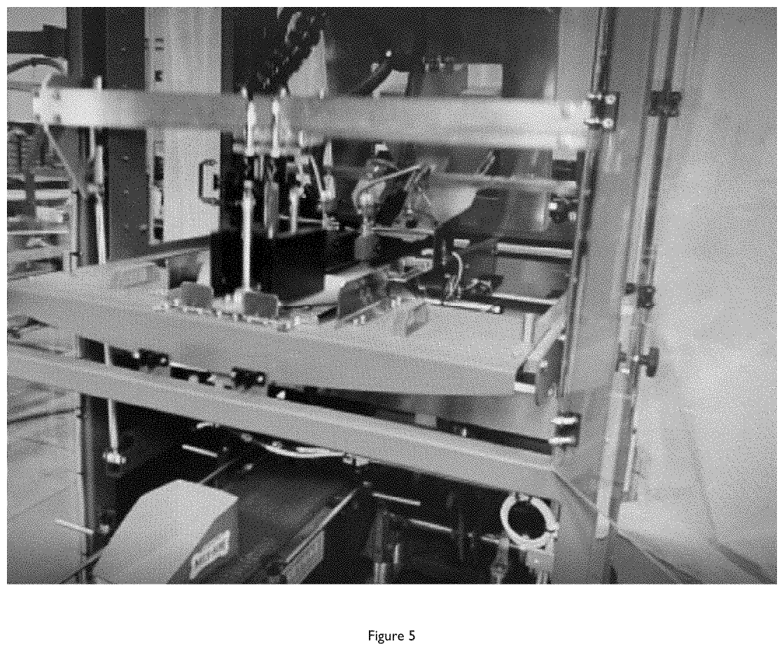

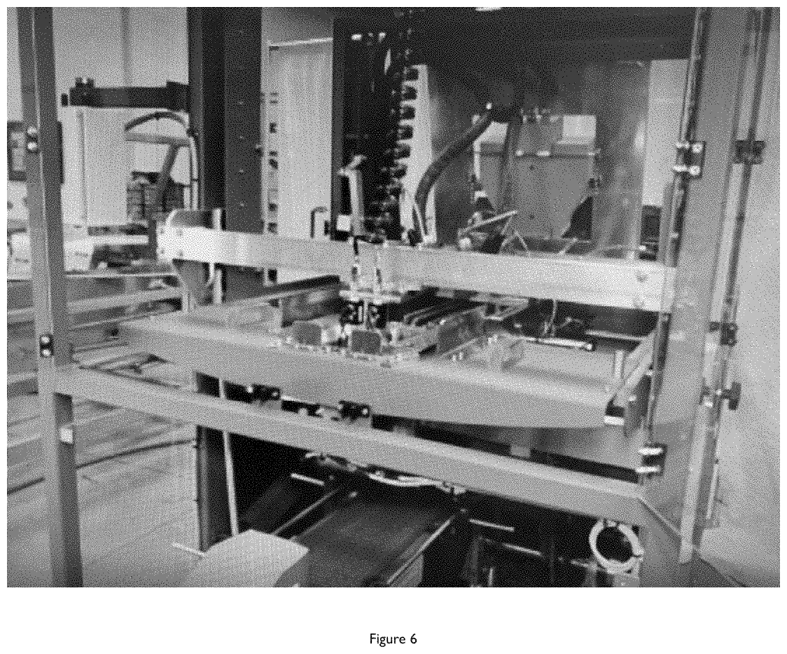

FIGS. 5 and 6 illustrate the plunger continues to drop and pushes the carton into a female cavity beneath;

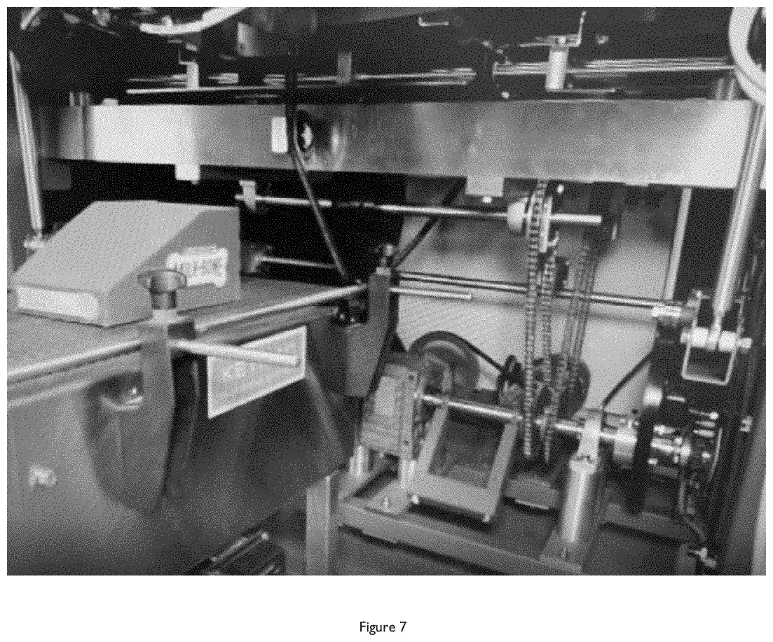

FIG. 7 illustrates the erected carton drops out and onto a conveyor; and

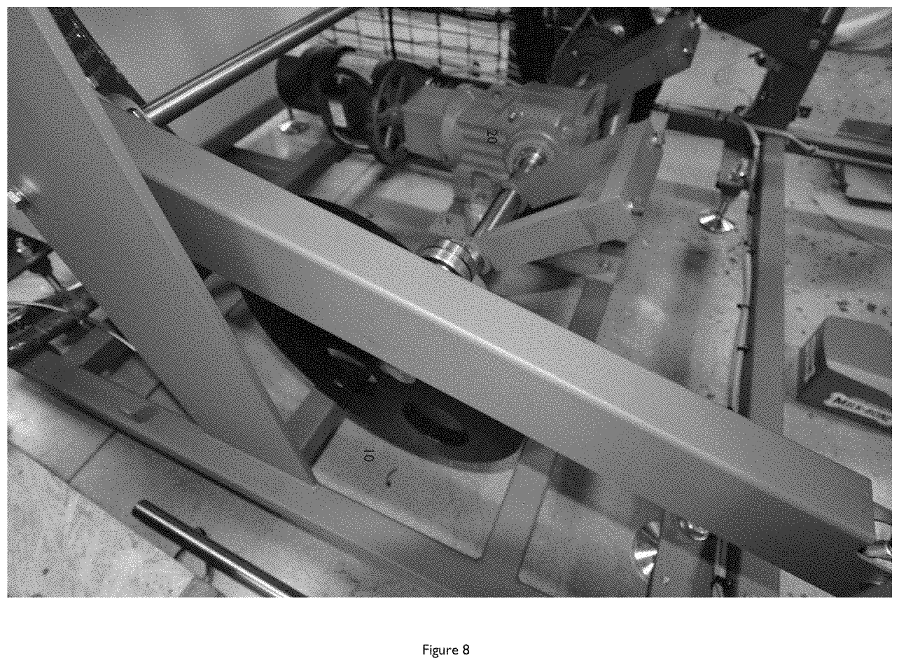

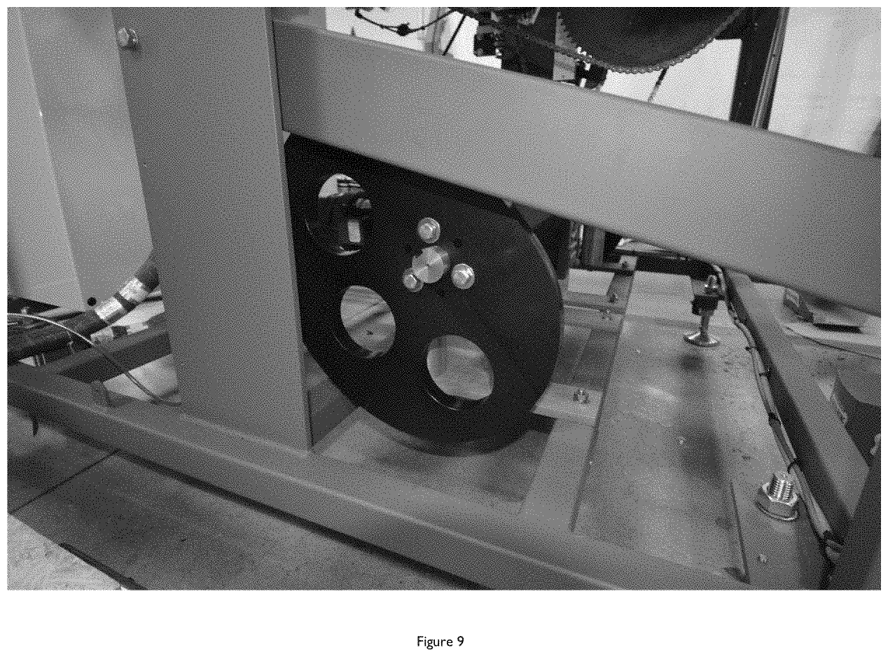

FIGS. 8 and 9 illustrate the cam and cam drive shaft.

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the following description, all orientational terms, such as upper, lower, radially and axially, are used in relation to the drawings and should not be interpreted as limiting on the invention.

FIG. 1—schematic drawing of a packaging machine formed according to an embodiment of the present invention.

FIGS. 2A to 2S show the vertical cycle/plunge process of the machine of FIG. 1.

Shown in the drawings is an eccentric cam 10 and a cam follower 20 (a pivot arm) which controls a plunger 30.

The plunger is pushed up and allowed to drop down. The key is that, due to the profile of the cam, the carton plunger is not driven in the down direction when forming the carton. As a result the machine is generally safe and cannot seriously jam or cause injury.

In this embodiment when the plunger arm doesn't reach the bottom dead centre a sensor stops the motion to clear cartons or objects, stopping the down motion of the plunger.

FIG. 3—a packaging machine formed according to a further embodiment. The plunger is shown in an uppermost position.

FIG. 4—a carton is moved over the cavity and beneath the plunger and the plunger is allowed to drop.

FIGS. 5/6—the plunger continues to drop and pushes the carton into a female cavity beneath.

The carton is erected and the plunger moves back up to the position shown in FIG. 3, being “pushed” up by a cam action.

FIG. 7—the erected carton drops out and onto a conveyor.

FIG. 8/9—the cam and cam drive shaft.

Some embodiments include a carton hopper from the bottom of which cartons are taken and laid flat and then conveyed along to sit above the female cavity before the plunger moves down and into the cavity.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A forming machine for erecting a packaging article, the machine comprising a female cavity and a plunger which moves up and down in a generally vertical cycle and which can push a packaging article down into the cavity when moving down, in which the plunger is driven to move up and is not driven to move down.

2. A machine as claimed in claim 1, in which the plunger is pushed up.

3. A machine as claimed in claim 1, in which the plunger is allowed to drop down under its own weight.

4. A machine as claimed in claim 1, comprising a cam.

5. A machine as claimed in claim 4, in which the cam is an eccentric cam.

6. A machine as claimed in claim 4, in which the cam is non-circular.

7. A machine as claimed in claim 6, in which the cam is generally oval, ovoid, elliptical or ellipsoidal.

8. A machine as claimed in claim 4, comprising a cam shaft.

9. A machine as claimed in claim 8, in which the cam shaft is balanced.

10. A machine as claimed in claim 4, in which a cam follower is provided on or by the cam.

11. A machine as claimed in claim 10, in which the cam follower is or carries an arm which in turn controls/carries the plunger.

12. A machine as claimed in claim 1, in which the plunger is not directly connected to a mechanical drive.

13. A machine as claimed in claim 1, comprising a plunger arm which pivots up and down.

14. A machine as claimed in any claim 13, in which if the plunger arm does not reach bottom dead centre the machine stops downwards motion of the plunger.

15. A machine as claimed in claim 14, in which a sensor stops the motion to clear cartons or objects, stopping the down motion of the plunger.

16. A machine as claimed in claim 1, in which a plunger or plunger arm rolls on top of a cam profile.

17. A machine as claimed in claim 1, further comprising a hopper.

18. A machine as claimed in claim 1, further comprising an inbound conveyor.

19. A machine as claimed in claim 1, further comprising an outbound conveyor.

20. A method of erecting a packaging article comprising: providing a female cavity and a plunger which moves up and down in a generally vertical cycle; pushing a packaging article down into the female cavity by moving the plunger down; driving the plunger up; and allowing the plunger to drop down.
